(19) United States
(12) Patent Application Publication
(10) Pub. No.: US 2024/0281633 A1
(43) Pub. Date: Aug. 22, 2024

(54) WIRELESS ELECTRONIC TAG OR TAGS

(71) Applicant: Endur ID, Inc., Hampton, NH (US)

(72) Inventor: Albert Larose, Dracut, MA (US)

(21) Appl. No.: 18/584,206

(22) Filed: Feb. 22, 2024

Related U.S. Application Data
(60) Provisional application No. 63/447,439, filed on Feb. 22, 2023.
(60) Provisional application No. 63/458,995, filed on Apr. 13, 2023.

(51) Int. Cl. G06K 19/077; H04W 4/029

(52) U.S. Cl. CPC G06K 19/07758; H04W 4/029

(57) ABSTRACT

Provided is an electronic tag or strip of tags. Each tag can comprise a top layer and a bottom layer, wherein the bottom layer is an adhesive layer, and a circuit coupled to a battery and a wireless transmitter collectively enclosed between the top and bottom layers and operative to broadcast a signal. The wireless transmitter can be a Bluetooth Low Energy (BLE) transmitter, having 4.x BLE tag technology. Also provided can be an asset or inventory tracking system comprising a plurality of tags, each tag adherable or adhered to a tagged asset, and a computer in wireless communication with the plurality of tags and configured to process the signals broadcast by the plurality of tags to determine locations of each of the tagged assets.

### RELATED APPLICATIONS

This application claims the benefit of U.S. Provisional Application No. 63/447,439, filed Feb. 22, 2023, and U.S. Provisional Application No. 63/458,995, filed Apr. 13, 2023, the content of each of which are incorporated herein by reference in their entireties.

### FIELD

The inventive concepts relate to low energy wireless electronic tags, such as low-cost adhesive electronic tags that broadcast a wireless signal.

### BACKGROUND

At this time, low-cost adhesive Bluetooth Low Energy (BLE) tags do not exist. Such tags would have utility in a variety of areas, such as asset and/or inventory tracking. For example, such tags would be useful in combination with Nokia's High Accuracy Indoor Positioning (HAIP) system, which can be used to track assets (e.g., goods, vehicles, staff, equipment, etc.). Such tags could also be useful in other types of asset tracking systems.

### SUMMARY

In accordance with aspects of the inventive concepts, provided is a wireless electronic tag, comprising: a top layer and a bottom layer, wherein the bottom layer is an adhesive layer; and a circuit having a wireless transmitter coupled to a battery collectively enclosed between the top and bottom layers and operative to broadcast a signal.

In various embodiments, the wireless transmitter is a Bluetooth Low Energy (BLE) transmitter.

In various embodiments, the Bluetooth transmitter comprises 4.x and/or 5.x BLE tag technology.

In various embodiments, the signal is a location and/or tracking signal.

In various embodiments, the signal includes a MAC address.

In various embodiments, the tag is a Nokia High Accuracy Indoor Positioning (HAIP) compatible tag and the broadcast signal includes information compatible with HAIP.

In various embodiments, the adhesive is water resistant.

In various embodiments, the tag further comprises a light, wherein the light is a light emitting diode (LED) coupled to the circuit and viewable through the top layer and/or bottom layer.

In various embodiments, the circuit is configured to turn the light on in a blinking pattern while broadcasting the signal.

In various embodiments, the blinking pattern turns the light on and then off once every 1-10 seconds.

In various embodiments, the tag further comprises an ON mechanism that couples the battery to the circuit, wherein actuation of the ON mechanism activates the circuit to broadcast the signal.

In various embodiments, the ON mechanism is a one-time ON mechanism configured to activate the circuit indefinitely without turning off.

In various embodiments, the ON mechanism is or includes a switch, button, or pull tab.

In various embodiments, the tag further comprises an ON/OFF mechanism configured to selectively couple and decouple the battery to and from the circuit, respectively.

In various embodiments, the circuit includes logic configured to determine a power level and/or state of the battery and the broadcasted signal comprises an indication of the power level and/or state of the battery.

In various embodiments, the indication of the power level and/or state of the battery can be a low battery indication or state.

In various embodiments, the tag is water resistant and/or waterproof.

In various embodiments, the tag is an asset and/or inventory tracking tag and the adhesive layer is configured to adhere to an asset and/or inventory to be tracked.

In accordance with another aspect of the inventive concept, provided is strip of wireless electronic tags, comprising a plurality of electronic tags. Each electronic tag comprises a top layer and a bottom layer, wherein the bottom layer is an adhesive layer; and a circuit having a wireless transmitter coupled to a battery collectively enclosed between the top and bottom layers and operative to broadcast a signal. The plurality of electronic tags is connected together by perforated edges that enable separation of each electronic tag individually from the strip.

In various embodiments, the wireless transmitter is a Bluetooth Low Energy (BLE) transmitter.

In various embodiments, the Bluetooth transmitter comprises 4.x and/or 5.x BLE tag technology.

In various embodiments, the signal is a location and/or tracking signal.

In various embodiments, the signal includes a MAC address.

In various embodiments, each of the plurality of electronic tags is a Nokia High Accuracy Indoor Positioning (HAIP) compatible tag and the broadcast signal includes information compatible with HAIP.

In various embodiments, the adhesive is water resistant.

In various embodiments, the tag further comprising a light emitting diode (LED) coupled to the circuit and viewable through the top layer and/or bottom layer.

In various embodiments, the circuit is configured to turn the light on in a blinking pattern while broadcasting the signal.

In various embodiments, the blinking pattern turns the light on and then off once every 1-10 seconds.

In various embodiments, each of the plurality of electronic tags further comprising an ON mechanism that couples the battery to the circuit, wherein actuation of the ON mechanism activates the circuit to broadcast the signal.

In various embodiments, the ON mechanism is a one-time ON mechanism configured to activate the circuit indefinitely without turning off.

In various embodiments, the ON mechanism is or includes a switch, button, or pull tab.

In various embodiments, each of the plurality of electronic tags further comprising an ON/OFF mechanism configured to selectively couple and decouple the battery to and from the circuit, respectively.

In various embodiments, the circuit includes logic configured to determine a power level and/or state of the battery and the broadcasted signal comprises an indication of the power level and/or state of the battery.

In various embodiments, the indication of the power level and/or state of the battery can be a low battery indication or state.

In various embodiments, each electronic tag is water resistant and/or waterproof.

In various embodiments, each of the plurality of electronic tags is an asset and/or inventory tracking tag with a peel layer removably covering the adhesive layer and configured for peel and stick application to the asset and/or inventory.

In accordance with another aspect of the inventive concepts, provided is an asset and/or inventory tracking system comprising a plurality of tags. Each tag is adherable and/or adhered to a tagged asset. And each electronic tag comprises: a top layer and a bottom layer, wherein the bottom layer is an adhesive layer; and a circuit having a wireless transmitter coupled to a battery collectively enclosed between the top and bottom layers and operative to broadcast a signal. And the system further comprising a computer in wireless communication with the plurality of tags and configured to process the signals broadcast by the plurality of tags to determine locations of each of the tagged assets.

In various embodiments, the wireless transmitter is a Bluetooth Low Energy (BLE) transmitter.

In various embodiments, the Bluetooth transmitter comprises 4.x and 5.x BLE tag technology.

In various embodiments, the signal is a location and/or tracking signal.

In various embodiments, the signal includes a MAC address.

In various embodiments, each of the plurality of tags is a Nokia High Accuracy Indoor Positioning (HAIP) compatible tag and the broadcast signal includes information compatible with HAIP.

In various embodiments, the adhesive is water resistant.

In various embodiments, each of the plurality of tags further comprising a light, wherein the light is a light emitting diode (LED) coupled to the circuit and viewable through the top layer and/or bottom layer.

In various embodiments, the circuit is configured to turn the light on in a blinking pattern while broadcasting the signal.

In various embodiments, the blinking pattern turns the light on and then off once every 1-10 seconds.

In various embodiments, each of the plurality of tags further comprising an ON mechanism that couples the battery to the circuit, wherein actuation of the ON mechanism activates the circuit to broadcast the signal.

In various embodiments, the ON mechanism is a one-time ON mechanism configured to activate the circuit indefinitely without turning off.

In various embodiments, the ON mechanism is or includes a switch, button, or pull tab.

In various embodiments, each of the plurality of tags further comprising an ON/OFF mechanism configured to selectively couple and decouple the battery to and from the circuit, respectively.

In various embodiments, the circuit includes logic configured to determine a power level and/or state of the battery and the broadcasted signal comprises an indication of the power level and/or state of the battery.

In various embodiments, the indication of the power level and/or state of the battery includes a low battery indication or state.

In various embodiments, each of the plurality of electronic tags is water resistant and/or waterproof.

In various embodiments, each of the plurality of electronic tags is an asset and/or inventory tracking tag configured to adhere to an asset and/or inventory to be tracked.

In accordance with another aspect of the inventive concepts, provided is a method of tracking at least one asset, comprising: adhering a wireless electronic tag to at least one asset; at least one adhered tag broadcasting its signal; and for each adhered tag of an asset broadcasting its signal, locating and/or tracking the asset by at least one computer in wireless communication with each adhered tag based on the signal broadcast from the adhered tag of the asset. Each tag comprises a top layer and a bottom layer, wherein the bottom layer is an adhesive layer; and a circuit having a wireless transmitter that couples to a battery collectively enclosed between the top and bottom layers and operative to broadcast a signal.

In various embodiments, the wireless transmitter is a Bluetooth Low Energy (BLE) transmitter.

In various embodiments, the Bluetooth transmitter comprises 4.x and/or 5.x BLE tag technology.

In various embodiments, the signal is a location and/or tracking signal.

In various embodiments, the signal includes a MAC address.

In various embodiments, the tag is a Nokia High Accuracy Indoor Positioning (HAIP) compatible tag and the broadcast signal includes information compatible with HAIP.

In various embodiments, the adhesive is water resistant.

In various embodiments, each tag further comprises a light, wherein the light is a light emitting diode (LED) coupled to the circuit and viewable through the top layer and/or bottom layer.

In various embodiments, the circuit is configured to turn the light on in a blinking pattern while broadcasting the signal.

In various embodiments, the blinking pattern turns the light on and then off once every 1-10 seconds.

In various embodiments, each tag further comprises an ON mechanism that couples the battery to the circuit, wherein actuation of the ON mechanism activates the circuit to broadcast the signal.

In various embodiments, wherein the ON mechanism is a one-time ON mechanism configured to activate the circuit indefinitely without turning off.

In various embodiments, the ON mechanism is or includes a switch, button, or pull tab.

In various embodiments, each tag further comprises an ON/OFF mechanism configured to selectively couple and decouple the battery to and from the circuit, respectively.

In various embodiments, the circuit includes logic configured to determine a power level and/or state of the battery and the broadcasted signal comprises an indication of the power level and/or state of the battery.

In various embodiments, the indication of the power level and/or state of the battery can be a low battery indication or state.

In various embodiments, the tag is water resistant and/or waterproof.

In various embodiments, the tag is an asset and/or inventory tracking tag and the adhesive layer is configured to adhere to an asset and/or inventory to be tracked.

### BRIEF DESCRIPTION OF THE DRAWINGS

The foregoing and other features and advantages of embodiments of the present inventive concept will be apparent from the more particular description of embodiments of the inventive concept, as illustrated in the accompanying drawings in which like reference characters refer to the same elements throughout the different views. The drawings are not necessarily to scale, emphasis instead being placed upon illustrating the principles of the inventive concept in the drawings.

FIG. 1 illustrates a top view of an adhesive wireless tag, according to an example embodiment of the present inventive concepts.

FIG. 2 illustrates a bottom view of an adhesive wireless tag, according to an example embodiment of the present inventive concepts.

FIG. 3 illustrates a side view of an adhesive wireless tag, according to an example embodiment of the present inventive concepts.

FIG. 4 illustrates a view of an open adhesive wireless tag showing the internal components, according to an example embodiment of the present inventive concepts.

FIG. 5 illustrates a view of an open adhesive wireless tag showing the external surfaces, according to an example embodiment of the present inventive concepts.

FIG. 6A illustrates an embodiment of a wireless tag, according to an example embodiment of the present inventive concepts.

FIG. 6B illustrates an embodiment of a strip of a wireless tag, according to an example embodiment of the present inventive concepts.

FIG. 7 illustrates a block-diagram of an asset tracking system comprising a plurality of wireless tags, according to an example embodiment of the present inventive concepts.

FIG. 8 is a flow diagram of an embodiment of a method for tracking an asset and/or inventory, in accordance with aspects of the inventive concepts.

### DETAILED DESCRIPTION

The foregoing and other objects, features and advantages of the embodiments of inventive concept will be apparent from the more particular description of embodiments of inventive concept, as illustrated in the accompanying drawings. The drawings are not necessarily to scale, emphasis instead being placed upon illustrating the principles of the inventive concept in the drawings.

The terminology used herein is for the purpose of describing particular embodiments and is not intended to be limiting of the inventive concept. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

It will be understood that, although the terms first, second, third etc. may be used herein to describe various limitations, elements, components, regions, layers and/or sections, these limitations, elements, components, regions, layers and/or sections should not be limited by these terms. These terms are only used to distinguish one limitation, element, component, region, layer or section from another limitation, element, component, region, layer or section. Thus, a first limitation, element, component, region, layer or section discussed below could be termed a second limitation, element, component, region, layer or section without departing from the teachings of the present application.

It will be further understood that when an element is referred to as being “on” or “connected” or “coupled” to another element, it can be directly on or above, or connected or coupled to, the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). When an element is referred to herein as being “over” another element, it can be over or under the other element, and either directly coupled to the other element, or intervening elements may be present, or the elements may be spaced apart by a void or gap.

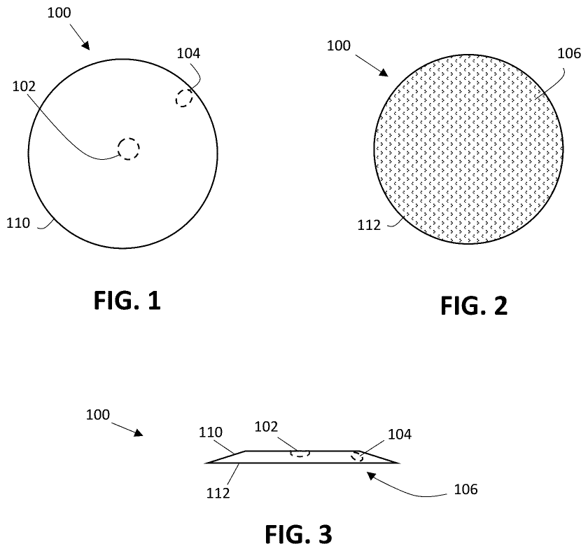

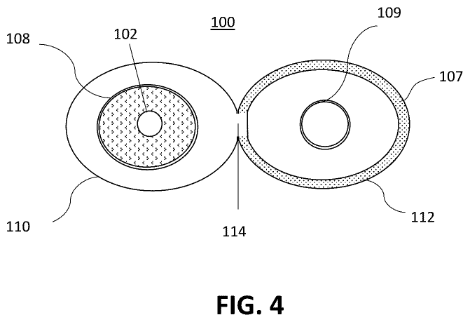

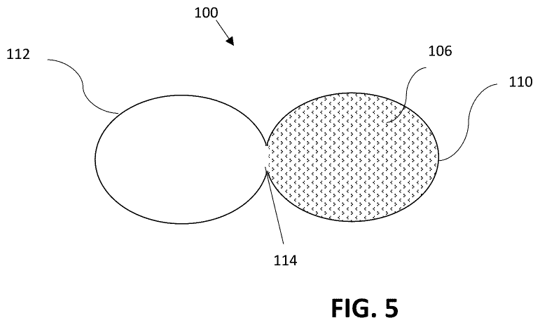

FIG. 1 illustrates a top view of an adhesive wireless tag, according to an example embodiment of the present inventive concept. FIG. 2 illustrates a bottom view of an adhesive wireless tag, according to an example embodiment of the present inventive concept. FIG. 3 illustrates a side view of an adhesive wireless tag, according to an example embodiment of the present inventive concept. FIG. 4 illustrates a view of an open adhesive wireless tag showing the internal components, according to an example embodiment of the present inventive concept. FIG. 5 illustrates a view of an open adhesive wireless tag showing the external surfaces, according to an example embodiment of the present inventive concept.

Referring to the figures, in accordance with aspects of the inventive concepts, provided is an electronic tag 100, comprising a top layer 110 and a bottom layer 112 and a circuit 108 having a wireless transmitter coupled to a battery 109, which are collectively enclosed between the top 110 and bottom 112 layers and operative to broadcast a signal. The circuit can take the form of a printed circuit board (PCB) comprising logic needed to carry out tracking and broadcast signal functionality of the tag. The top and bottom layers can be glued together to form a secure, permanent closure with the circuit and battery disposed inside, between the layers.

The top and/or bottom layer can include an adhesive 106 to form an adhesive layer enabling the tag to be stuck to a physical item (or asset) to enable location tracking of the item/asset. The adhesive can be a permanent adhesive, in some embodiments, that makes it extremely difficult, if not impossible, to remove the tag without damaging the tag and/or setting of an alarm state of the tag. The seal formed between the layer can be a waterproof or water-resistant seal. In order to form the seal between the two layers, portions of a perimeter of an internal surface of the top layer and/or an internal surface 107 of the bottom layer may include an adhesive.

In FIGS. 1-5, the top layer 110 and the bottom layer 112 of the electronic tag 100 are illustrated as being circular; however, the present inventive concepts are not limited thereto. The top layer 110 and the bottom layer 112, in fact the tag itself, may take one of various shapes and sizes so long as the circuit 108 and the battery 109 are sealed within the top 110 and the bottom 112 layers. In FIGS. 1-5, the top layer 110 and the bottom layer 112 are coupled at a hinge 114; however, the present inventive concepts is not limited thereto. The top layer 110 may be sealed onto the bottom layer 112 without a hinge 114.

In various embodiments, the wireless transmitter 112 can be a Bluetooth Low Energy (BLE) transmitter. In various embodiments, the Bluetooth transmitter comprises 4.x BLE tag technology. In various embodiments, the Bluetooth transmitter comprises 4.0 BLE tag technology.

In preferred embodiments, the tag 100 can include 4.x Bluetooth Low Energy (BLE) tag technology packaged as described herein. In various embodiments, the 4.x BLE technology can include various iterations of 4.0 BLE technology, e.g., 4.1 BLE and so on. In various embodiments the BLE technology can be 4.0 BLE technology. In various embodiments, the BLE technology can include BLE 5.x technology

In general, BLE technology is known, as described in A Basic Introduction to BLE 4.x Security by Matthew Bon (Oct. 25, 2016); Bluetooth 4.0: An Introduction to Bluetooth Low Energy-Part I by Mikhail Galeev, EE Times (Jul. 14, 2011); and The basics of Bluetooth Low Energy (BLE), EDN.com (Oct. 14, 2016) (Published at edn.com/the-basics-of-bluetooth-low-energy-ble/), each of which is incorporated herein by reference.

Descriptions of BLE technology are also provided in Bluetooth Core Specification v5.1, version 1.0.1, by Martin Woolley (Dec. 9, 2020) and The Bluetooth® Low Energy Primer, version 1.0.1, by Martin Woolley (Jun. 6, 2022), each of which is incorporated herein by reference.

In various embodiments, the tag 100 can be configured to interact with Nokia's High Accuracy Indoor Positioning (HAIP) technology. In various embodiments, the tag 100 can include a plurality of cost reductions measures, including one or more of:
1) Eliminate a duress button and associated discrete electronics on the PCB.
2) Eliminate all other electronics that do not involve location beaconing.
3) Utilize a small/lower cost coin cell battery, e.g., that would last 1-2 weeks blinking every second or longer intervals if desired.
4) Optionally package the PCB with a low-cost label that wraps around the PCB and use a double-sided water-resistant adhesive with release liner to enable a peel and stick approach to applying the tag to inventory items. For example, in FIG. 2 a peelable layer (not shown) can cover adhesive 106 until a user removes the peel layer to reveal the adhesive for sticking to a body or object.

In various embodiments, the broadcast signal is or includes a location signal. In various embodiments, the broadcast signal includes a MAC address.

In various embodiments, the tag is a Nokia High Accuracy Indoor Positioning (HAIP) compatible tag and the broadcast signal includes information compatible with HAIP. In various embodiments, the tag is compatible with Nokia's HAIP BLE 4.x technology and evolutions of Nokia's HAIP to BLE 5.x and beyond.

In various embodiments, the adhesive 106 and/or tag 100 is water resistant and/or waterproof.

In various embodiments, the tag can optionally comprise a light 102 (see FIG. 1), such as a light emitting diode (LED) coupled to the circuit. The light can be viewable or visible through the top and/or bottom layer, in various embodiments. In various embodiments, the circuit can be configured to turn the light on in a blinking pattern while broadcasting. In various embodiments, the circuit can be configured to turn the light on/off in a blinking pattern while broadcasting. In various embodiments, the blinking pattern turns the light on once per 1-10 seconds. For example, the circuit can turn the light on than off once every 1 second, 2, seconds, 3 seconds, 4 seconds, 5 seconds, 6 seconds, 7 seconds, 8 seconds, 9 seconds, or 10 seconds. In other embodiments, other intervals or periods could be used to turn the light on and off.

In various embodiments, the tag 100 can optionally comprise an ON mechanism 104 configured to couple the battery 109 to the circuit 108. In various embodiments, the ON switch 104 can be a one-time ON mechanism configured to activate the circuit indefinitely without turning off. In various embodiments, the ON mechanism can be or include a switch, button, or pull tab.

In various embodiments, the ON mechanism or switch 104 of the tag 100 can optionally comprise an ON/OFF mechanism or switch configured to selectively couple and decouple the battery 109 to and from the circuit 108, respectively.

In various embodiments, the circuit is configured to determine a power level and/or state of the battery 109 and the broadcasted signal comprises an indication of the power level and/or state of the battery 109. In various embodiments, the indication of the power level and/or state of the battery 109 can be a low battery indication or state. In various embodiments, the light 102 could change state when battery power goes below a threshold. In some embodiments, in the low battery state the light 102 can blink red or be solid red. In other embodiments, a different color or pattern could be used to indicate a low battery state.

In various embodiments, at least one of the top 110 and bottom 112 layers is water resistant and/or waterproof. In various embodiments, the tag is water resistant or waterproof.

In various embodiments, the tag 100 can be an asset and/or inventory tracking tag. In some embodiments, the tag is affixable to a container, a box or other packaging, e.g., through adhesion.

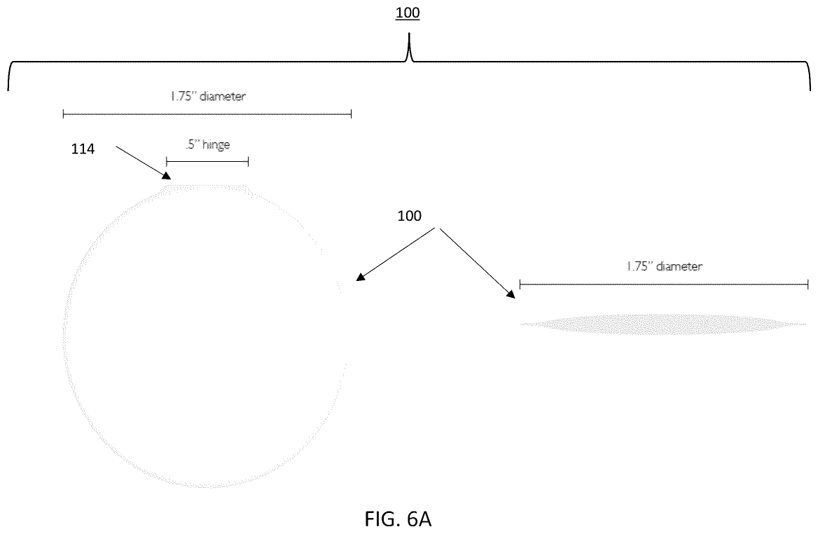

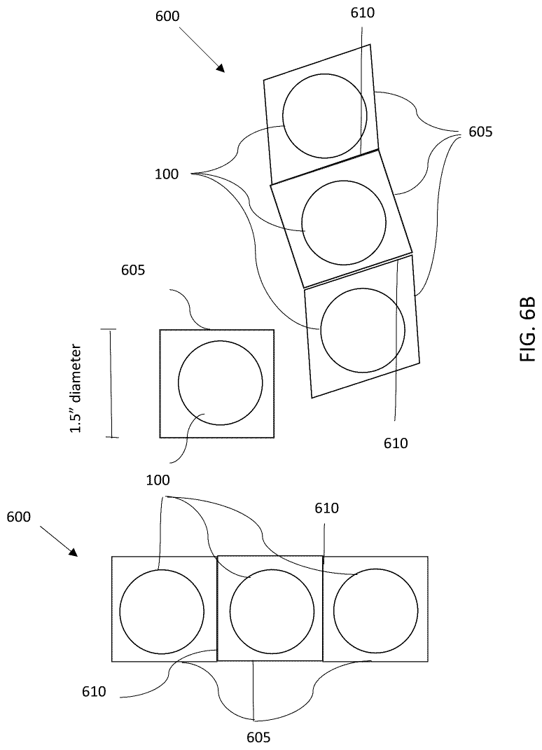

FIG. 6A illustrates an embodiment of a wireless tag 100, according to an example embodiment of the present inventive concepts. In FIG. 6A, a single adhesive wireless tag is shown including an example of possible dimensions of various aspects of the tag. For example, the wireless tag 100 may comprise a 1.75″ diameter and the length of the hinge 114 connecting the top 110 and bottom 112 layers may be 0.5″; however, the present inventive concepts are not limited thereto.

FIG. 6B illustrates an embodiment of a wireless tag strip, according to an example embodiment of the present inventive concepts. In FIG. 6B strips 600 of individual adhesive wireless tags 100 are shown including an example of possible dimensions of various aspects of the tag. In FIG. 6B, each strip 600 includes a plurality of individual wireless electronic tags 100, within a package 605. Each of the wireless electronic tags 100 includes a top layer and a bottom layer and a circuit having a wireless transmitter and coupled to a battery, which are collectively enclosed between the top and bottom layers and operative to broadcast a signal. The circuit can take the form of a printed circuit board (PCB) comprising logic needed to carry out tracking and broadcast signal functionality. The top and/or bottom layer of a tag 100 can be adhered together as described above and include an adhesive to form an adhesive layer enabling the tag to be stuck to a physical item (or asset) to enable location tracking of the item/asset.

As an example, the wireless electronic tag package 605 can have a diameter of 1.5″; however, the present inventive concepts are not limited thereto.

In this example, a strip 600 includes a plurality of individual tags 605 joined by perforated and tearable edges 610. The perforated edges 610 allow an individual tag packages 605 to be separated from the strip 600 for individual use.

In various embodiments, the individual tags 100 are in the shape of a circle. However, the present inventive concepts are not limited thereto. The individual tag packages 605 may take any shape in which the electronic tag packages 605 may be connected together by perforated edges 610 to form a strip or, in other embodiments, a sheet, of tags.

In various embodiments, therefore, the inventive concepts include a strip 600 of electronic tags 100, in any of the forms described herein, that are connected together by perforated edges 610 that enable separation of each electronic tag 100 or tag package 605 individually from the strip 600. In other embodiments, a plurality of tags can be packaged and or coupled together in other manners.

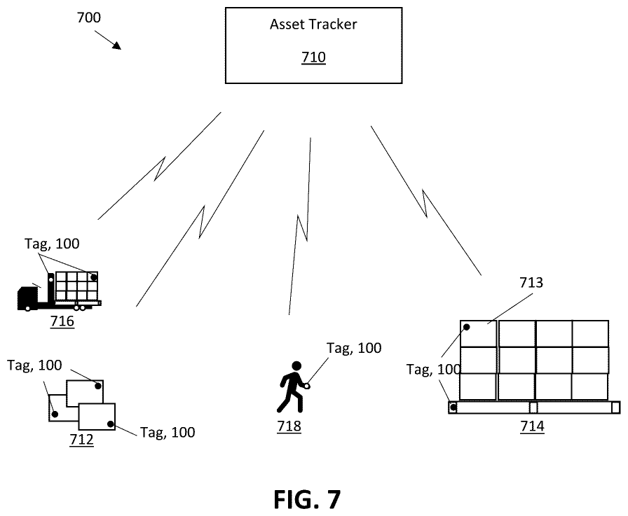

FIG. 7 illustrates a block-diagram view of an asset and/or inventory tracking system 700 comprising plurality of wireless tags 100, according to an example embodiment of the present inventive concept.

In various embodiments, the asset and/or inventory tracking system 700 comprises a plurality of tags 100, each tag 100 adhered to a tagged asset, and at least one computer (or Asset Tracker 710) in wireless communication with the plurality of tags and configured to process the signals broadcast by the plurality of tags to determine locations of each of the tagged assets.

The tagged assets can take any of a variety of forms, such as inventory, e.g., individual goods 712, cases of goods 713, and/or pallets 714 carrying goods 713 and/or cases of goods 713. In various embodiments, the pallet or other goods container 714 can be tracked as an asset and/or the goods 712 and/or 713 on the pallet can be tracked as assets. In some embodiments, a vehicle, such as a pallet truck 716, can be a tracked asset and the load carried by the vehicle could be a tracked asset or assets. In other embodiments, other types of vehicles could be tagged and tracked.

In some embodiments, a human carrying or equipped with a portable device 718 can be a tracked asset. That is, a tag 100 may be provided on the portable device 718. The present invention has broad scope and its not necessarily limited to the goods or other assets that can be tagged and tracked.

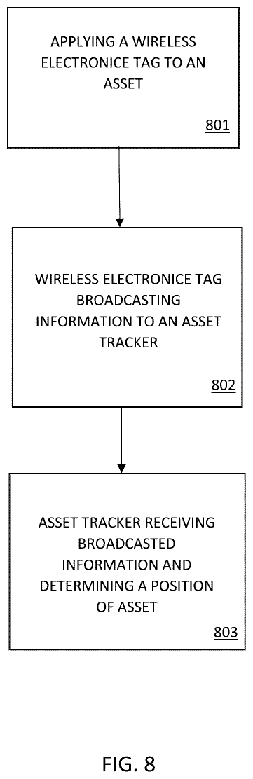

FIG. 8 is a flow diagram of an embodiment of a method for tracking an asset and/or inventory, in accordance with aspects of the inventive concepts. In step 801, at least one wireless electronic tag, as described herein, is applied to an asset, for example, individual goods, cases of goods, pallets carrying goods and/or cases of goods, and/or a vehicle, for example, carrying a tracked asset. In step 802, the at least one wireless electronic tag broadcasts information to an asset tracker, for example, a computer. The information being broadcast may include, for example, location information and/or battery level status information. In step 803, the asset tracker may receive the broadcasted information and determine a location of the tracked asset. In various embodiments, the broadcasting may be in response to the circuit being powered up, e.g., through use of an ON mechanism or an ON/OFF mechanism as described above.

In the described embodiments, the tag includes an adhesive backing, but in other embodiments, the adhesive backing could be omitted. In some embodiments, other types of attachment mechanisms could be used.

While the foregoing has described what are considered to be the best mode and/or other preferred embodiments, it is understood that various modifications can be made therein and that aspects of the inventive concepts herein may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the inventive concepts, which are, for clarity, described in the context of separate embodiments, may also be provide in combination in a single embodiment. Conversely, various features of the inventive concepts which are, for brevity, described in the context of a single embodiment may also be provided separately or in any suitable sub-combination.

For example, it will be appreciated that all of the features set out in any of the claims (whether independent or dependent) can combined in any given way.

Below follows an itemized list of statements describing embodiments in accordance with the inventive concepts:

1. A wireless electronic tag, comprising:
a top layer and a bottom layer, wherein the bottom layer is an adhesive layer; and
a circuit having a wireless transmitter coupled to a battery collectively enclosed between the top and bottom layers and operative to broadcast a signal.

2. The tag of statement 1, or any other statement or combination of statements, wherein the wireless transmitter is a Bluetooth Low Energy (BLE) transmitter.

3. The tag of statement 2, or any other statement or combination of statements, wherein the Bluetooth transmitter comprises 4.x and/or 5.x BLE tag technology.

4. The tag of statement 1, or any other statement or combination of statements, wherein the signal is a location and/or tracking signal.

5 The tag of statement 4, or any other statement or combination of statements, wherein the signal includes a MAC address.

6. The tag of statement 4, or any other statement or combination of statements, wherein the tag is a Nokia High Accuracy Indoor Positioning (HAIP) compatible tag and the broadcast signal includes information compatible with HAIP.

7. The tag of statement 1, or any other statement or combination of statements, wherein the adhesive is water resistant.

8. The tag of statement 1, or any other statement or combination of statements, further comprising a light, wherein the light is a light emitting diode (LED) coupled to the circuit and viewable through the top layer and/or bottom layer.

9 The tag of statement 8, or any other statement or combination of statements, wherein the circuit is configured to turn the light on in a blinking pattern while broadcasting the signal.

10. The tag of statement 9, or any other statement or combination of statements, wherein the blinking pattern turns the light on and then off once every 1-10 seconds.

11. The tag of statement 1, or any other statement or combination of statements, further comprising an ON mechanism that couples the battery to the circuit, wherein actuation of the ON mechanism activates the circuit to broadcast the signal.

12. The tag of statement 11, or any other statement or combination of statements, wherein the ON mechanism is a one-time ON mechanism configured to activate the circuit indefinitely without turning off.

13. The tag of statement 11, or any other statement or combination of statements, wherein the ON mechanism is or includes a switch, button, or pull tab.

14. The tag of statement 1, or any other statement or combination of statements, further comprising an ON/OFF mechanism configured to selectively couple and decouple the battery to and from the circuit, respectively.

15. The tag of statement 1, or any other statement or combination of statements, wherein the circuit includes logic configured to determine a power level and/or state of the battery and the broadcasted signal comprises an indication of the power level and/or state of the battery.

16. The tag of statement 15, or any other statement or combination of statements, wherein the indication of the power level and/or state of the battery can be a low battery indication or state.

17. The tag of statement 1, or any other statement or combination of statements, wherein the tag is water resistant and/or waterproof.

18. The tag of statement 1, or any other statement or combination of statements, wherein the tag is an asset and/or inventory tracking tag and the adhesive layer is configured to adhere to an asset and/or inventory to be tracked.

19. A strip of wireless electronic tags, comprising:
a plurality of electronic tags, each electronic tag comprising:
a top layer and a bottom layer, wherein the bottom layer is an adhesive layer; and
a circuit having a wireless transmitter coupled to a battery collectively enclosed between the top and bottom layers and operative to broadcast a signal,
wherein the plurality of electronic tags is connected together by perforated edges that enable separation of each electronic tag individually from the strip.

20 The strip of electronic tags of statement 19, or any other statement or combination of statements, wherein the wireless transmitter is a Bluetooth Low Energy (BLE) transmitter.

21. The strip of electronic tags of statement 20, or any other statement or combination of statements, wherein the Bluetooth transmitter comprises 4.x and/or 5.x BLE tag technology.

22. The strip of electronic tags of statement 19, or any other statement or combination of statements, wherein the signal is a location and/or tracking signal.

23. The strip of electronic tags of statement 22, or any other statement or combination of statements, wherein the signal includes a MAC address.

24 The strip of electronic tags of statement 22, or any other statement or combination of statements, wherein each of the plurality of electronic tags is a Nokia High Accuracy Indoor Positioning (HAIP) compatible tag and the broadcast signal includes information compatible with HAIP.

25. The strip of electronic tags of statement 19, or any other statement or combination of statements, wherein the adhesive is water resistant.

26. The strip of electronic tags of statement 19, or any other statement or combination of statements, further comprising a light, wherein the light is a light emitting diode (LED) coupled to the circuit and viewable through the top layer and/or bottom layer.

27. The strip of electronic tags of statement 26, or any other statement or combination of statements, wherein the circuit is configured to turn the light on in a blinking pattern while broadcasting the signal.

28. The strip of electronic tags of statement 27, or any other statement or combination of statements, wherein the blinking pattern turns the light on and then off once every 1-10 seconds.

29. The strip of electronic tags of statement 19, or any other statement or combination of statements, wherein each of the plurality of electronic tags further comprising an ON mechanism that couples the battery to the circuit, wherein actuation of the ON mechanism activates the circuit to broadcast the signal.

30. The strip of electronic tags of statement 29, or any other statement or combination of statements, wherein the ON mechanism is a one-time ON mechanism configured to activate the circuit indefinitely without turning off.

31. The strip of electronic tags of statement 29, or any other statement or combination of statements, wherein the ON mechanism is or includes a switch, button, or pull tab.

32. The strip of electronic tags of statement 19, or any other statement or combination of statements, wherein each of the plurality of electronic tags further comprising an ON/OFF mechanism configured to selectively couple and decouple the battery to and from the circuit, respectively.

33. The strip of electronic tags of statement 19, or any other statement or combination of statements, wherein the circuit includes logic configured to determine a power level and/or state of the battery and the broadcasted signal comprises an indication of the power level and/or state of the battery.

34. The strip of electronic tags of statement 33, or any other statement or combination of statements, wherein the indication of the power level and/or state of the battery can be a low battery indication or state.

35. The strip of electronic tags of statement 19, or any other statement or combination of statements, wherein each electronic tag is water resistant and/or waterproof.

36. The strip of electronic tags of statement 19, or any other statement or combination of statements, wherein each of the plurality of electronic tags is an asset and/or inventory tracking tag with a peel layer removably covering the adhesive layer and configured for peel and stick application to the asset and/or inventory.

37. An asset and/or inventory tracking system comprising:
a plurality of tags, each tag adherable and/or adhered to a tagged asset, each electronic tag comprising:
a top layer and a bottom layer, wherein the bottom layer is an adhesive layer; and
a circuit having a wireless transmitter coupled to a battery collectively enclosed between the top and bottom layers and operative to broadcast a signal; and
a computer in wireless communication with the plurality of tags and configured to process the signals broadcast by the plurality of tags to determine locations of each of the tagged assets.

38 The asset and/or inventory tracking system of statement 37, or any other statement or combination of statements, wherein the wireless transmitter is a Bluetooth Low Energy (BLE) transmitter.

39. The asset and/or inventory tracking system of statement 38, or any other statement or combination of statements, wherein the Bluetooth transmitter comprises 4.x and 5.x BLE tag technology.

40. The asset and/or inventory tracking system of statement 37, or any other statement or combination of statements, wherein the signal is a location and/or tracking signal.

41. The asset and/or inventory tracking system of statement 40, or any other statement or combination of statements, wherein the signal includes a MAC address.

42. The asset and/or inventory tracking system of statement 40, or any other statement or combination of statements, wherein each of the plurality of tags is a Nokia High Accuracy Indoor Positioning (HAIP) compatible tag and the broadcast signal includes information compatible with HAIP.

43. The asset and/or inventory tracking system of statement 37, or any other statement or combination of statements, wherein the adhesive is water resistant.

44. The asset and/or inventory tracking system of statement 37, or any other statement or combination of statements, wherein each of the plurality of tags further comprising a light, wherein the light is a light emitting diode (LED) coupled to the circuit and viewable through the top layer and/or bottom layer.

45. The asset and/or inventory tracking system of statement 44, or any other statement or combination of statements, wherein the circuit is configured to turn the light on in a blinking pattern while broadcasting the signal.

46. The asset and/or inventory tracking system of statement 45, or any other statement or combination of statements, wherein the blinking pattern turns the light on and then off once every 1-10 seconds.

47. The asset and/or inventory tracking system of statement 37, or any other statement or combination of statements, wherein each of the plurality of tags further comprising an ON mechanism that couples the battery to the circuit, wherein actuation of the ON mechanism activates the circuit to broadcast the signal.

48. The asset and/or inventory tracking system of statement 47, or any other statement or combination of statements, wherein the ON mechanism is a one-time ON mechanism configured to activate the circuit indefinitely without turning off.

49. The asset and/or inventory tracking system of statement 47, or any other statement or combination of statements, wherein the ON mechanism is or includes a switch, button, or pull tab.

50. The asset and/or inventory tracking system of statement 37, or any other statement or combination of statements, wherein each of the plurality of tags further comprising an ON/OFF mechanism configured to selectively couple and decouple the battery to and from the circuit, respectively.

51 The asset and/or inventory tracking system of statement 37, or any other statement or combination of statements, wherein the circuit includes logic configured to determine a power level and/or state of the battery and the broadcasted signal comprises an indication of the power level and/or state of the battery.

52. The asset and/or inventory tracking system of statement 37, or any other statement or combination of statements, wherein the indication of the power level and/or state of the battery includes a low battery indication or state.

53. The asset and/or inventory tracking system of statement 37, or any other statement or combination of statements, wherein each of the plurality of electronic tags is water resistant and/or waterproof.

54. The asset and/or inventory tracking system of statement 37, or any other statement or combination of statements, wherein each of the plurality of electronic tags is an asset and/or inventory tracking tag configured to adhere to an asset and/or inventory to be tracked.

55. A method of tracking at least one asset, comprising:
adhering a wireless electronic tag to at least one asset, each tag comprising:
a top layer and a bottom layer, wherein the bottom layer is an adhesive layer; and
a circuit having a wireless transmitter that couples to a battery collectively enclosed between the top and bottom layers and operative to broadcast a signal;
at least one adhered tag broadcasting its signal; and
for each adhered tag of an asset broadcasting its signal, locating and/or tracking the asset by at least one computer in wireless communication with each adhered tag based on the signal broadcast from the adhered tag of the asset.

56 The method of statement 55, or any other statement or combination of statements, wherein the wireless transmitter is a Bluetooth Low Energy (BLE) transmitter.

57. The method of statement 56, or any other statement or combination of statements, wherein the Bluetooth transmitter comprises 4.x and/or 5.x BLE tag technology.

58. The method of statement 55, or any other statement or combination of statements, wherein the signal is a location and/or tracking signal.

59. The method of statement 58, or any other statement or combination of statements, wherein the signal includes a MAC address.

60. The method of statement 58, or any other statement or combination of statements, wherein the tag is a Nokia High Accuracy Indoor Positioning (HAIP) compatible tag and the broadcast signal includes information compatible with HAIP.

61. The method of statement 55, or any other statement or combination of statements, wherein the adhesive is water resistant.

62. The method of statement 55, or any other statement or combination of statements, further comprising a light, wherein the light is a light emitting diode (LED) coupled to the circuit and viewable through the top layer and/or bottom layer.

63. The method of statement 62, or any other statement or combination of statements, wherein the circuit is configured to turn the light on in a blinking pattern while broadcasting the signal.

64. The method of statement 63, or any other statement or combination of statements, wherein the blinking pattern turns the light on and then off once every 1-10 seconds.

65. The method of statement 55, or any other statement or combination of statements, further comprising an ON mechanism that couples the battery to the circuit, wherein actuation of the ON mechanism activates the circuit to broadcast the signal.

66. The method of statement 65, or any other statement or combination of statements, wherein the ON mechanism is a one-time ON mechanism configured to activate the circuit indefinitely without turning off.

67. The method of statement 65, or any other statement or combination of statements, wherein the ON mechanism is or includes a switch, button, or pull tab.

68. The method of statement 55, or any other statement or combination of statements, further comprising an ON/OFF mechanism configured to selectively couple and decouple the battery to and from the circuit, respectively.

69. The method of statement 55, or any other statement or combination of statements, wherein the circuit includes logic configured to determine a power level and/or state of the battery and the broadcasted signal comprises an indication of the power level and/or state of the battery.

70. The method of statement 69, or any other statement or combination of statements, wherein the indication of the power level and/or state of the battery can be a low battery indication or state.

71. The method of statement 55, or any other statement or combination of statements, wherein the tag is water resistant and/or waterproof.

72. The method of statement 55, or any other statement or combination of statements, wherein the tag is an asset and/or inventory tracking tag and the adhesive layer is configured to adhere to an asset and/or inventory to be tracked.

What is claimed is:

1. A wireless electronic tag, comprising:
a top layer and a bottom layer, wherein the bottom layer is an adhesive layer; and
a circuit having a wireless transmitter coupled to a battery collectively enclosed between the top and bottom layers and operative to broadcast a signal,
wherein the wireless transmitter is a Bluetooth Low Energy (BLE) transmitter comprising 4.x and/or 5.x BLE tag technology, and
wherein the signal is a location and/or tracking signal.

2. The tag of claim 1, wherein the signal includes a MAC address.

3. The tag of claim 1, wherein the tag is a Nokia High Accuracy Indoor Positioning (HAIP) compatible tag and the broadcast signal includes information compatible with HAIP.

4. The tag of claim 1, wherein the adhesive is water resistant.

5. The tag of claim 1, further comprising a light, wherein the light is a light emitting diode (LED) coupled to the circuit and viewable through the top layer and/or bottom layer.

6. The tag of claim 5, wherein the circuit is configured to turn the light on in a blinking pattern while broadcasting the signal.

7. The tag of claim 6, wherein the blinking pattern turns the light on and then off once every 1-10 seconds.

8. The tag of claim 1, further comprising an ON mechanism that couples the battery to the circuit, wherein actuation of the ON mechanism activates the circuit to broadcast the signal.

9. The tag of claim 8, wherein the ON mechanism is a one-time ON mechanism configured to activate the circuit indefinitely without turning off.

10. The tag of claim 8, wherein the ON mechanism is or includes a switch, button, or pull tab.

11. The tag of claim 1, further comprising an ON/OFF mechanism configured to selectively couple and decouple the battery to and from the circuit, respectively.

12. The tag of claim 1, wherein the circuit includes logic configured to determine a power level and/or state of the battery and the broadcasted signal comprises an indication of the power level and/or state of the battery.

13. The tag of claim 12, wherein the indication of the power level and/or state of the battery can be a low battery indication or state.

14. The tag of claim 1, wherein the tag is water resistant and/or waterproof.

15. The tag of claim 1, wherein the tag is an asset and/or inventory tracking tag and the adhesive layer is configured to adhere to an asset and/or inventory to be tracked.

16. A strip of wireless electronic tags, comprising:
a plurality of electronic tags, each electronic tag comprising:
a top layer and a bottom layer, wherein the bottom layer is an adhesive layer; and
a circuit having a wireless transmitter coupled to a battery collectively enclosed between the top and bottom layers and operative to broadcast a signal,
wherein the plurality of electronic tags is connected together by perforated edges that enable separation of each electronic tag individually from the strip, and
wherein the wireless transmitter is a Bluetooth Low Energy (BLE) transmitter that comprises 4.x and/or 5.x BLE tag technology, wherein the signal is a location and/or tracking signal.

17. The strip of electronic tags of claim 16, wherein each of the plurality of electronic tags is a Nokia High Accuracy Indoor Positioning (HAIP) compatible tag and the broadcast signal includes information compatible with HAIP.

18. The strip of electronic tags of claim 16, wherein the tag includes a light emitting diode (LED) coupled to the circuit and viewable through the top layer and/or bottom layer and the circuit is configured to turn the light on in a blinking pattern while broadcasting the signal.

19. The strip of electronic tags of claim 16, wherein each of the plurality of electronic tags is an asset and/or inventory tracking tag with a peel layer removably covering the adhesive layer and configured for peel and stick application to the asset and/or inventory.

20. An asset and/or inventory tracking system comprising:
a plurality of tags, each tag adherable and/or adhered to a tagged asset, each electronic tag comprising:
a top layer and a bottom layer, wherein the bottom layer is an adhesive layer; and
a circuit having a wireless transmitter coupled to a battery collectively enclosed between the top and bottom layers and operative to broadcast a signal,
wherein the wireless transmitter is a Bluetooth Low Energy (BLE) transmitter, the signal is a location and/or tracking signal, and each of the plurality of electronic tags is water resistant and/or waterproof; and
a computer in wireless communication with the plurality of tags and configured to process the signals broadcast by the plurality of tags to determine locations of each of the tagged assets.

21. The asset and/or inventory tracking system of claim 20, wherein the Bluetooth transmitter comprises 4.x and 5.x BLE tag technology and the signal includes a MAC address.

22. The asset and/or inventory tracking system of claim 20, wherein each of the plurality of tags is a Nokia High Accuracy Indoor Positioning (HAIP) compatible tag and the broadcast signal includes information compatible with HAIP.

23. The asset and/or inventory tracking system of claim 20, wherein each of the plurality of tags further comprises a light, wherein the light is a light emitting diode (LED) coupled to the circuit and viewable through the top layer and/or bottom layer and wherein the circuit is configured to turn the light on in a blinking pattern while broadcasting the signal.

24. The asset and/or inventory tracking system of claim 20, wherein each of the plurality of tags further comprises an ON mechanism that couples the battery to the circuit, wherein actuation of the ON mechanism activates the circuit to broadcast the signal,
wherein the ON mechanism is a one-time ON mechanism configured to activate the circuit indefinitely without turning off, and
wherein the ON mechanism is or includes a switch, button, or pull tab.

25. The asset and/or inventory tracking system of claim 20, wherein each of the plurality of electronic tags is an asset and/or inventory tracking tag configured to adhere to an asset and/or inventory to be tracked.
